(19) United States
(12) Patent Application Publication
(10) Pub. No.: US 2011/0140978 A1
(43) Pub. Date: Jun. 16, 2011

(54) Antenna device

(75) Inventor: Akihiro Maruyama, Kanagawa (JP)

(73) Assignee: Samsung Electronics Co., Ltd., Suwon-si (KR)

(21) Appl. No.: 12/928,117

(22) Filed: Dec. 3, 2010

(30) Foreign Application Priority Data
Dec. 11, 2009 (JP) 2009-282113
Sep. 14, 2010 (KR) 10-2010-0090029

(51) Int. Cl. H01Q 21/30

(52) U.S. Cl. 343/725

(57) ABSTRACT

An antenna device includes a ground plate, a dielectric body disposed at an end of the ground plate, an L-shaped foldable antenna disposed at one side of the dielectric body, a wide-band monopole antenna disposed at an opposite side of the dielectric body, and a power supply disposed between the L-shaped foldable antenna and the wide-band monopole antenna.

### CROSS-REFERENCE TO RELATED APPLICATION(S) AND CLAIM OF PRIORITY

The present application is related to and claims the priority under 35 U.S.C. §119(a) of applications entitled “Antenna Device” filed in the Japanese Industrial Property Office on Dec. 11, 2009 and assigned Serial No. 2009-282113, and filed in the Korean Industrial Property Office on Sep. 14, 2010 and assigned Serial No. 10-2010-0090029, the contents of which are hereby incorporated by reference.

### TECHNICAL FIELD OF THE INVENTION

The present invention relates to an antenna device, and more particularly, to a small-sized built-in multi-band antenna device installed within a wireless communication apparatus.

### BACKGROUND OF THE INVENTION

In recent years, built-in antennas for wireless communication apparatuses have been developed. Such antennas include, for example, ultra-wide band (UWB) dedicated built-in antennas suitable for high speed data communications, built-in antennas for cellular phones, and the like. As wireless communication apparatuses become small-sized, their antennas are also required to be smaller.

Thus, in built-in antennas for wireless communication apparatuses, the shapes of the elements of inverted-L shaped or inverted-F shaped antennas or their power supplies are made to be tuned to realize the antennas in wide bands. For example, an impedance can be adjusted by resonance of at least two frequency bands by an antenna with a spherical element and an L-shaped element (see Japanese Laid-Open Patent Application No. 2005-94501), or the wide band characteristics can be realized by the shape of a linear or planar antenna element or its capacity coupling to the ground plate (see Japanese Laid-Open Patent Application No. 2008-295090). In addition, a switch mounted to a serpentine antenna element can be controlled to support a multi-band tendency (International Laid-Open Patent Application No. 08/088463).

Due to a recent demand for support of a variety of wireless communication methods and international roaming of wireless communication apparatuses, for example, GSM850/900 needs to be adapted to a frequency band of 0.824 to 0.960 Hz, UMTS (WCDMA), to a frequency band of 1.92 to 2.17 GHz, and WiMAX, to 2.5 to 2.7 and 3.3 to 3.8 GHz. However, the above-described antenna devices cannot support all the wireless communication methods.

Further, when the shape of an antenna element is inverted L-shaped or inverted F-shaped, a Q-value representing the sharpness of a resonance of a small-sized antenna increases, lowering its efficiency and narrowing its frequency bands. Thus, a separate antenna may be required to support a plurality of wireless communication methods in the conventional antenna devices. Moreover, if it is impossible to secure a sufficient mounting space, the antenna device cannot be made small-sized.

### SUMMARY OF THE INVENTION

To address the above-discussed deficiencies of the prior art, it is a primary object to provide an antenna device that covers a frequency band corresponding to a plurality of wireless communication methods with a single antenna device, is operated in a wide bandwidth, and is made small-sized.

An antenna device according to an embodiment of the present invention includes a ground plate, a dielectric body disposed at an end of the ground plate, an L-shaped foldable antenna disposed at one side of the dielectric body, a wide-band monopole antenna disposed at an opposite side of the dielectric body, and a power supply disposed between the L-shaped foldable antenna and the wide-band monopole antenna. According to embodiments of the antenna device, the electrical interference between an L-shaped foldable antenna and a wide-band monopole antenna can be reduced, making it possible to obtain the resonance characteristics at a high frequency band while maintaining the resonance characteristics at a low frequency band.

A portion of the L-shaped foldable antenna may be serpentine and a portion of the wide-band dipole antenna is tapered. According to embodiments of the antenna device, the resonance characteristics at a high frequency band can be widened.

The power supply may be disposed adjacent to an intermediate portion of the end of the ground plate. According to embodiments of the antenna device, the interference between the L-shaped foldable antenna and the wide-band monopole antenna can be reduced, making it easy to support a desired frequency band.

Portions of the L-shaped foldable antenna and the wide-band monopole antenna may be disposed in the vicinity of the ground plate. According to embodiments of the antenna device, excellent VSWR characteristics can be obtained while maintaining the resonance characteristics at a low frequency band and a high frequency band.

The L-shaped foldable antenna may include a tunable circuit having a plurality of variable capacitance diodes, and if a bias voltage applied from an external power source is varied, the capacitance of the variable capacitance diode may be varied such that the tunable circuit adjusts a resonance frequency of the L-shaped foldable antenna. According to embodiments of the antenna device, the resonance characteristics can be easily varied to a desired one at a low frequency band.

The dielectric body may be a thin film, the L-shaped foldable antenna may be disposed on one surface of the dielectric body, and the wide-band monopole antenna may be disposed at one end of an opposite surface of the dielectric body. According to embodiments of the antenna device, the antenna device can be made small-sized.

The dielectric body may be formed with a print board. According to embodiments of the antenna device, manufacturing costs can be reduced.

A wireless communication apparatus according to an embodiment of the present invention includes one of the above-described antenna devices. According to embodiments of the wireless communication apparatus, a plurality of wireless communication methods can be supported.

As above-described, according to embodiments of the antenna device and wireless communication apparatus of the present intention, a single antenna device can cover a frequency band corresponding to a plurality of wireless communication methods, can be operated in a wide bandwidth, and can be made small-sized. Furthermore, the wireless communication apparatus can provide a plurality of cellular methods.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1A illustrates an antenna device based on two general design conditions according to an embodiment of the present disclosure;

FIG. 1B illustrates a modified example of the antenna device of FIG. 1A;

FIG. 1C illustrates an enlarged view of an antenna portion of FIG. 1A;

FIG. 1D illustrates an enlarged view of an antenna portion of FIG. 1B;

FIG. 2 illustrates the VSWR characteristics of the antenna devices of FIGS. 1A through 1D;

FIG. 3A illustrates a modified example of the antenna device of FIG. 1A;

FIG. 3B illustrates a modified example of the antenna device of FIG. 1B;

FIG. 3C illustrates an enlarged view of an antenna portion of FIG. 3A;

FIG. 3D illustrates an enlarged view of an antenna portion of FIG. 3B;

FIG. 4 illustrates the VSWR characteristics of the antenna devices of FIGS. 1A and 3A through 3D;

FIG. 5A illustrates a modified example of the antenna device of FIG. 1A;

FIG. 5B illustrates a modified example of the antenna device of FIG. 3B;

FIG. 5C illustrates an enlarged view of an antenna portion of FIG. 5A;

FIG. 5D illustrates an enlarged view of an antenna portion of FIG. 5B;

FIG. 6 illustrates the VSWR characteristics of the antenna devices of FIGS. 5A through 5D;

FIG. 7A illustrates a surface of the antenna device according to an embodiment of the present disclosure;

FIG. 7B illustrates a rear surface of the antenna device;

FIG. 8A illustrates a state in which a wide-band monopole antenna is disposed on one surface along the lengthwise direction of the dielectric body of the antenna device of FIGS. 7A through 7D;

FIG. 8B illustrates a state in which an L-shaped foldable antenna is disposed on one surface along the lengthwise direction of the dielectric body of the antenna device of FIGS. 7A through 7D;

FIG. 9A illustrates a top surface of the antenna unit shown in FIGS. 7A through 7D;

FIG. 9B illustrates a surface of the antenna unit shown in FIG. 7A;

FIG. 9C illustrates a bottom surface of the antenna unit shown in FIG. 7A through 7D;

FIG. 9D illustrates a surface of the antenna unit shown in FIG. 7B;

FIG. 10 illustrates the VSWR characteristics of the antenna devices of FIGS. 8A and 8B;

FIG. 11 illustrates distribution of currents at a frequency of 0.9 GHz in the antenna device according to an embodiment of the present invention;

FIG. 12 illustrates distribution of currents at a frequency of 1.71 GHz in the antenna device according to an embodiment of the present invention;

FIG. 13 illustrates distribution of currents at a frequency of 2.17 GHz in the antenna device according to an embodiment of the present invention;

FIG. 14 illustrates distribution of currents at a frequency of 2.5 GHz in the antenna device according to an embodiment of the present invention;

FIG. 15 illustrates distribution of currents at a frequency of 3.5 GHz in the antenna device according to an embodiment of the present invention;

FIG. 16 illustrates distribution of currents at a frequency of 4.5 GHz in the antenna device according to an embodiment of the present invention;

FIG. 17 illustrates distribution of currents at a frequency of 5.5 GHz in the antenna device according to an embodiment of the present invention;

FIG. 18 illustrates current vectors generated when a current flows for a predetermined period of time at a frequency of 0.9 GHz in the antenna device according to the first embodiment of the present invention;

FIG. 19A illustrates a surface of the antenna device according to an embodiment of the present disclosure;

FIG. 19B illustrates a rear surface of the antenna device according to an embodiment of the present disclosure;

FIG. 20A illustrates a top surface of the antenna unit shown in FIGS. 19A and 19B;

FIG. 20B illustrates a surface of the antenna unit shown in FIG. 19A;

FIG. 20C illustrates a bottom surface of the antenna unit shown in FIGS. 19A and 19B;

FIG. 20D illustrates a surface of the antenna unit shown in FIG. 19B;

FIG. 21 illustrates the VSWR characteristics of the antenna devices of FIGS. 19A and 19B;

FIG. 22A illustrates a surface of the antenna device according to an embodiment of the present disclosure;

FIG. 22B illustrates a rear surface of the antenna device according to an embodiment of the present disclosure;

FIG. 23A illustrates a state in which a wide-band monopole antenna is disposed on one surface along the lengthwise direction of the dielectric body of the antenna device of FIGS. 22A and 22B;

FIG. 23B illustrates a state in which an L-shaped foldable antenna is disposed on one surface along the lengthwise direction of the dielectric body of the antenna device of FIGS. 22A and 22B;

FIG. 24 illustrates the VSWR characteristics of the antenna devices of FIGS. 22A and 22B;

FIG. 25A illustrates a surface of the antenna device according to an embodiment of the present disclosure;

FIG. 25B illustrates a rear surface of the antenna device according to an embodiment of the present disclosure;

FIG. 26A illustrates a state in which a wide-band monopole antenna is disposed on one surface along the lengthwise direction of the dielectric body of the antenna device of FIGS. 25A and 25B;

FIG. 26B illustrates a state in which an L-shaped foldable antenna is disposed on one surface along the lengthwise direction of the dielectric body of the antenna device of FIGS. 25A and 25B;

FIG. 27 illustrates the VSWR characteristics of the antenna devices of FIGS. 25A and 25B;

FIG. 28A illustrates a perspective view of the antenna device seen from the top according to an embodiment of the present disclosure;

FIG. 28B illustrates a perspective view of the antenna device seen from the bottom according to an embodiment of the present disclosure;

FIG. 28C illustrates an enlarged perspective view of the antenna unit shown in FIG. 28A;

FIG. 28D illustrates an enlarged top view of the antenna unit shown in FIG. 28B;

FIG. 29 illustrates a tunable circuit formed in the antenna unit shown in FIGS. 28A through 28D; and

FIG. 30 illustrates the VSWR characteristics shown when a voltage is varied in the antenna device of FIGS. 28A through 28D.

### DETAILED DESCRIPTION OF THE INVENTION

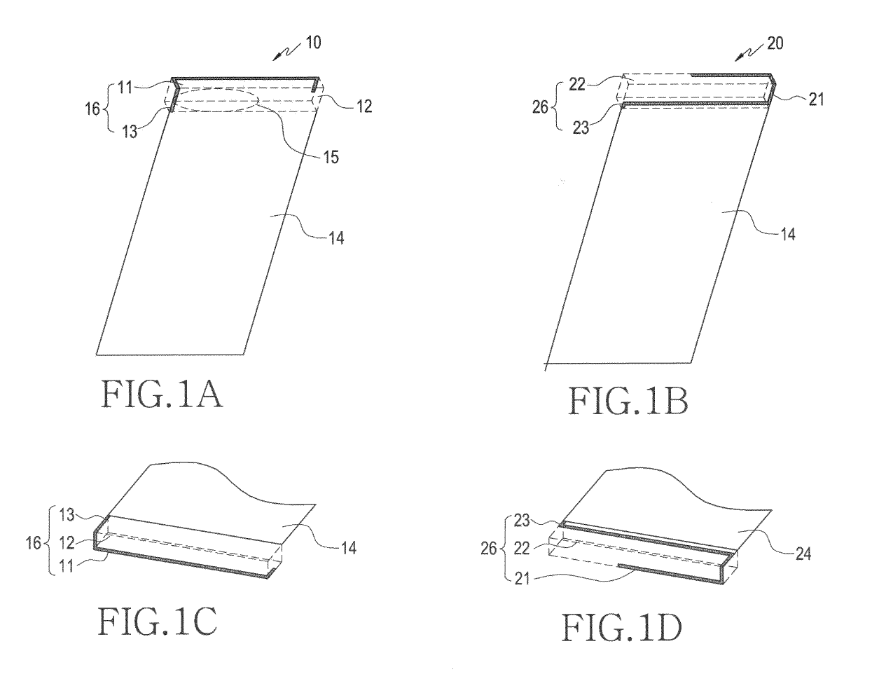

FIGS. 1A through 30, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication device.

In designing a built-in antenna for a wireless communication apparatus, various conditions such as its in-use frequency band, its antenna mounting position, and its ground plate position should be considered, and in particular, it is noted that (I) an antenna element around a power supply should be spaced apart from the ground plate with a polar force being interposed between them and (II) the power supply should be located around a corner of the ground plate.

As far as (I) is concerned, if the antenna element and the ground plate are too close together, the impedance of the antenna lowers due to their capacity coupling and the antenna element's electrical characteristics becomes deteriorated, which should be avoided. In particular, the current distribution in the antenna element around the power supply is high and is apt to influence the performance of the antenna. As far as (II) is concerned, the volume of the antenna element can be designed to be large on a side where power is supplied at a corner in order to obtain excellent antenna performance. Even when the antenna device is made small-sized and the number of multi-band elements increases, it is advantageous to supply power at a corner side.

Here, examples and modifications of antenna devices based on the two design conditions will be described with reference to FIGS. 1A through 6.

FIGS. 1A through 1D illustrate an example of an antenna device, wherein FIG. 1A illustrates an antenna device based on two general design conditions, FIG. 1B illustrates a modified example of the antenna device of FIG. 1A, FIG. 1C illustrates an enlarged view of an antenna portion of FIG. 1A, and FIG. 1D illustrates an enlarged view of an antenna portion of FIG. 1B.

Referring to FIGS. 1A and 1C, the antenna device 10 includes an antenna element 11, a dielectric body 12, a power source 13, and a ground plate 14. The antenna unit 16 includes the antenna element 11, the dielectric body 12, and the power source 13. Based on the two conditions, in the antenna device 10, (I) the antenna element around the power source 13 is spaced apart from the ground plate 14 with a polar force being interposed between them, and (II) the power supply 13 is disposed around a corner of the ground plate 14.

Referring to FIGS. 1B and 1D, the antenna device 20 includes an antenna element 21, a dielectric body 22, a power supply 23, and a ground plate 24. The antenna unit 26 includes the antenna element 21, the dielectric body 22, and the power source 23. The antenna device satisfies the condition (II), i.e. the power supply 23 is disposed around a corner of the ground plate 24 but fails to satisfy the condition (I), that is, the antenna element 21 around the power supply 23 is formed in the vicinity of the ground plate 24.

Each antenna unit 16 and 26 is a thin film having a length of 50 mm, a width of 10 mm, and a height of 5 mm and has a volume of 2.5 cc. Each ground plate 14 and 24 is a thin film having a size of 100 mm×50 mm which is generally mounted to a cellular phone. The antenna units 16 and 26 are installed at lengthwise ends of the ground plates 14 and 24. The dielectric bodies 12 and 22 are made of ABS (acrylonitrile, butadiene, and styrene), widely used in general built-in antennas.

Assuming that a frequency band (0.0824 to 0.894 GHz, 0.88 to 0.96 GHz) of GSM 850/900, i.e., a current cellular band and a central frequency of 0.9 GHz are used for the antenna devices 10 and 20 shown in FIGS. 1A and 1B and the antenna elements 11 and are L-shaped antennas of electromagnetic fields of ¼ λ, single-band antennas were designed using electromagnetic simulations and their characteristics were compared with each other.

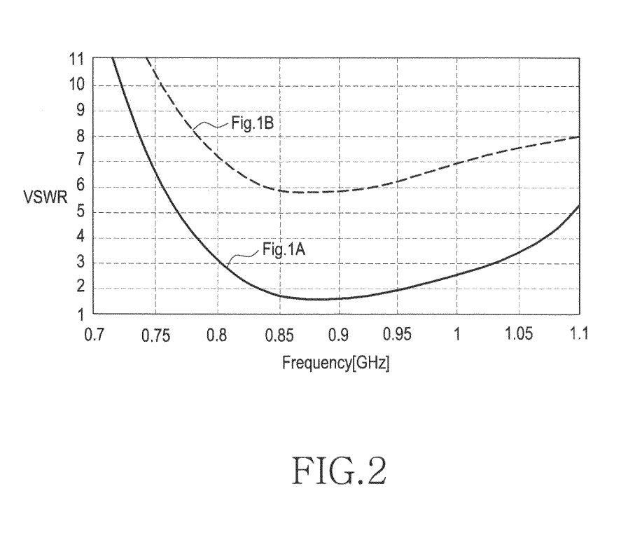

FIG. 2 is a graph illustrating the VSWR characteristics of the antenna devices 10 and 20 of FIGS. 1A and 1B;

Referring to FIG. 2, the antenna device 10 of FIG. 1A was designed in an ideal condition considering the conditions (I) and (II) and is satisfactory as a general wireless communication apparatus since it satisfies the specification of VSWR<3 in the bandwidth of approximately 230 MHz. Thus, the antenna device 10 shows excellent performance for a cellular phone.

In the antenna device 20 of FIG. 1A, the wire of the antenna element 21 extending from the power supply 23 is too close to the ground plate 24 and the VSWR of the antenna device 20 is deteriorated by lowering of the impedance due to the increase in its capacity coupling. Thus, the antenna device 20 is unsatisfactory for a cellular phone.

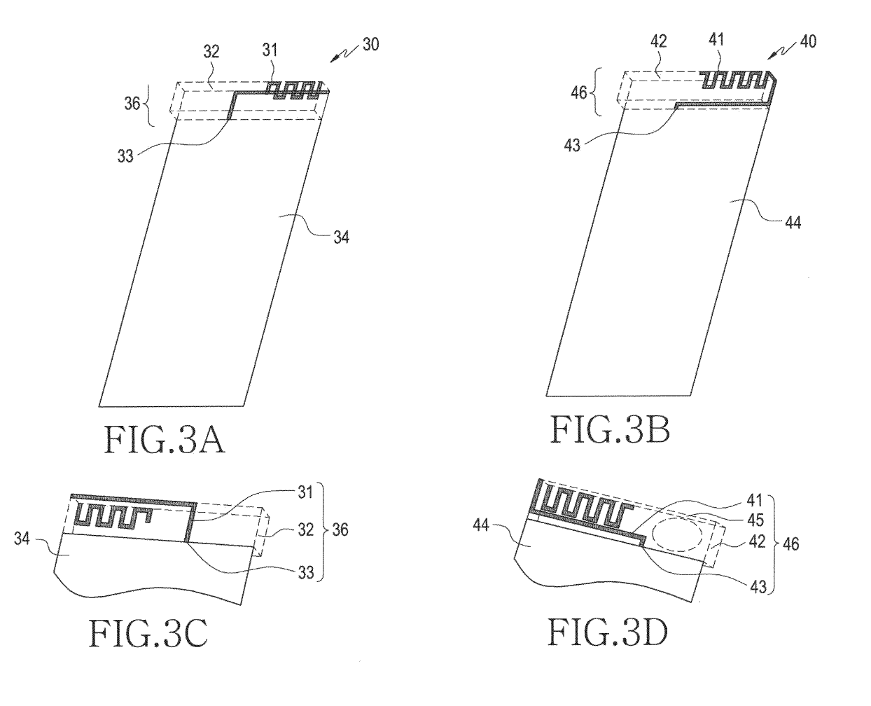

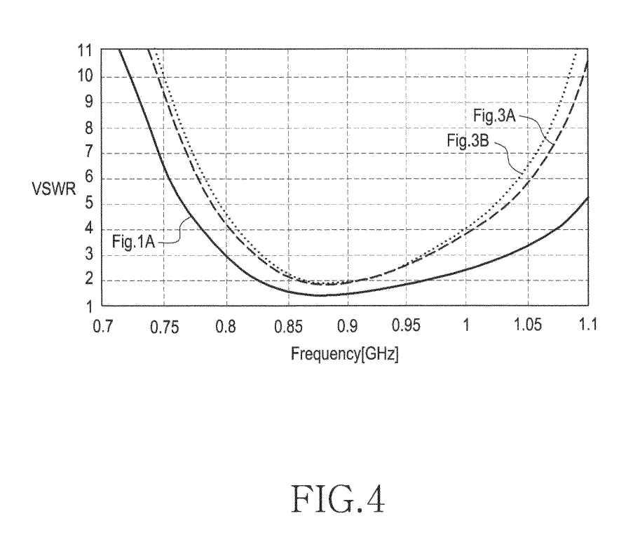

Next, antenna devices designed using electromagnetic simulations in which power is supplied at the vicinity of an intermediate portion of an upper edge of the ground plate instead of a corner of the ground plate and the tip end of an L-shaped antenna element of ¼ λ has an serpentine shape, are illustrated in FIGS. 3A and 3B.

FIGS. 3A and 3B illustrate another example of an antenna device, wherein FIG. 3A illustrates a modified example of the antenna device of FIG. 1A, FIG. 3B illustrates a modified example of the antenna device of FIG. 1B, FIG. 3C illustrates an enlarged view of an antenna portion of FIG. 3A, and FIG. 3D illustrates an enlarged view of an antenna portion of FIG. 3B.

Referring to FIGS. 3A and 3C, the antenna device 30 includes an antenna element 31, a dielectric body 32, a power supply 33, and a ground plate 34. The antenna unit 36 includes the antenna element 31, the dielectric body 32, and the power source 33. Referring to FIGS. 3B and 3D, the antenna device 40 includes an antenna element 41, a dielectric body 42, a power supply 43, and a ground plate 44. The antenna unit 46 includes the antenna element 41, the dielectric body 42, and the power source 43.

While in the antenna device 30 of FIG. 3A, the antenna element 31 is spaced apart from the ground plate 43 with a polar force being interposed between them considering the condition (I). In the antenna device 40 of FIG. 3B, the condition (I) is not considered and a portion of the antenna element 41 is formed around the ground plate 44. The condition (II) is not considered in the antenna devices 30 and 40, and the power supplies 33 and 43 are disposed around intermediate portions of the upper edges of the ground plates 34 and 44.

The antenna devices 30 and 40 have the same configurations as the antenna devices 10 and 20 except for the antenna elements 31 and 41. As in the antenna devices 10 and 20, the volume of the antenna units 36 and 46 is 2.5 cc (a length of 50 mm, a width of 10 mm, and a height of 5 mm), the size of the ground plates 34 and 44 is 100 mm×50 mm, and a central frequency is 0.9 GHz. The antenna devices 30 and 40 are designed as single-band antennas using electromagnetic simulations.

FIG. 4 is a graph illustrating the comparison of the VSWR characteristics of the antenna devices 30 and 40 of FIGS. 3A and 3B and the antenna device 10 of FIG. 1A.

Referring to FIG. 4, it can be seen in the comparison of the VSWR performances that as the tip ends of the antenna devices 30 and 40 are made serpentine and the volume of the antenna elements 31 and 41 are small, the performances of the antenna devices 30 and 40 become deteriorated. Thus, both the VSRWs and the frequency bands of the antenna devices 30 and 40 are deteriorated. However, there is nearly no difference between the performances of the antenna devices 30 and 40.

Referring to FIGS. 1 to 4, while the performances of the antennas are greatly different depending on the wiring methods when the power supplies are disposed at the corners of the ground plates according to the condition (II), the performances of the antennas are not easily deteriorated depending on the distances between the antenna elements and the ground plates or the wiring methods when power is supplied to intermediate portions of edges of the ground plates.

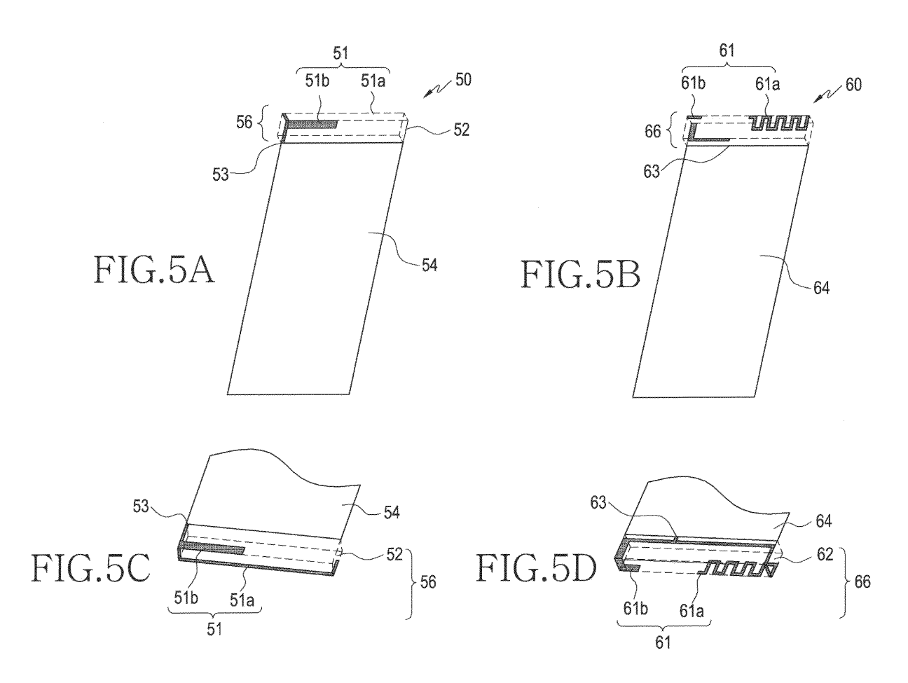

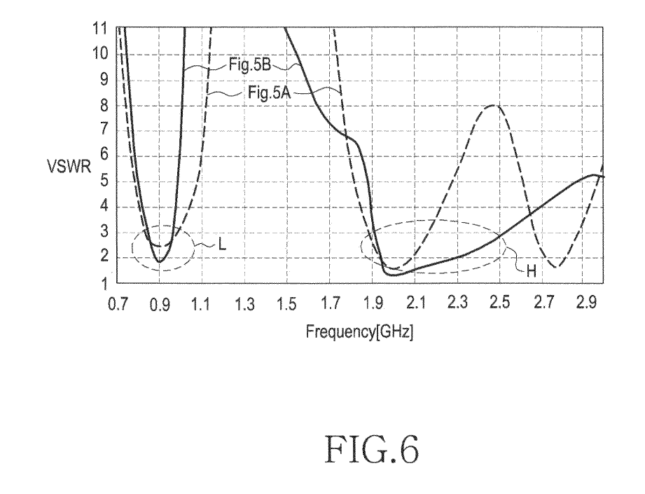

Next, antenna devices designed and wired by adding antenna elements into spaces 15 and 45 indicated by dotted lines in FIGS. 1A and 3 are illustrated in FIGS. 5A and 5B.

FIGS. 5A through 5D illustrate another example of an antenna device, wherein FIG. 5A illustrates a modified example of the antenna device of FIG. 1A, FIG. 5B illustrates a modified example of the antenna device of FIG. 3B, FIG. 5C illustrates an enlarged view of an antenna portion of FIG. 5A, and FIG. 5D illustrates an enlarged view of an antenna portion of FIG. 5B.

Referring to FIGS. 5A and 5C, the antenna device 50 includes an antenna element 51, a dielectric body 52, a power supply 53, and a ground plate 54. The antenna unit 56 includes the antenna element 51, the dielectric body 52, and the power supply 53. Referring to FIGS. 5B and 5D, the antenna device 60 includes an antenna element 61, a dielectric body 62, a power supply 63, and a ground plate 64. The antenna unit 66 includes the antenna element 61, the dielectric body 62, and the power supply 63.

The antenna elements 51 and 61 include element portions 51a and 61a having the same shapes as the antenna elements of FIGS. 1A and 3B and additional element portions 51b and 61b. The antenna devices 50 and 60 have the same configurations as the antenna devices 10 and 40 except for the additional element portions 51b and 61b.

The antenna devices 50 and 60 of FIGS. 5A and 5B are designed to have the resonance characteristics at approximately 2 GHz of UMTS (WCDMA), i.e. a cellular band used in a third generation phone.

FIG. 6 is a graph illustrating the VSWR characteristics of the antenna devices 50 and 60 of FIGS. 5A and 5B.

Referring to FIGS. 4 and 6, it can be seen from the comparison of the VSWR characteristics of the antenna device 10 of FIG. 1A and the antenna device 50 of FIG. 5A that the antenna device 50 realizes an antenna having the resonance characteristics at a high band of approximately 1.9 to 2.1 GHz while maintaining a low band of approximately 0.9 GHz by adding the element portion 51b to the antenna element 11 of the antenna device 10.

Referring to FIGS. 4 and 6, it can be seen from the comparison of the VSWR characteristics of the antenna device 40 of FIG. 3B and the antenna device 60 of FIG. 5B that the antenna device 60 realizes an antenna having excellent characteristics at approximately 0.9 GHz and obtaining the high band resonance characteristics at approximately 1.9 to 2.5 GHz while maintaining the low band resonance characteristics by adding the element portion 61b to the antenna element 41 of the antenna device 40.

Next, it can be seen from the comparison of the antenna device 50 of FIG. 5A and the antenna device 60 of FIG. 5B that, as indicated by a dotted line L, not the antenna device 50 but the antenna 60 has a band covering VSWR<2 and has excellent characteristics at around a frequency of GSM850/900. Thus, while the antenna device 10 has better characteristics than the antenna device 40 at around a frequency of GSM850/900 in the comparison with the single band antenna of FIG. 4, the antenna device 60 has better characteristics than the antenna device 50 by adding the element portions 51b and 61b to the antenna device 10 and the antenna device 40, which is reverse to the former embodiment. That is, it is determined that the antenna device 60 that employs a serpentine shape in the element portion 61a has the most excellent characteristics at around a frequency of GSM850/900.

Referring now to FIG. 6, the antenna device 60 of FIG. 5B has better VSWR performance than the antenna device 50 of FIG. 5A at a wide band even at around the frequency of UMTS (WCDMA) as indicated by a dotted line H.

Based on the above-described discussion, antenna devices according to the embodiments of the present invention will now be described.

### First Embodiment

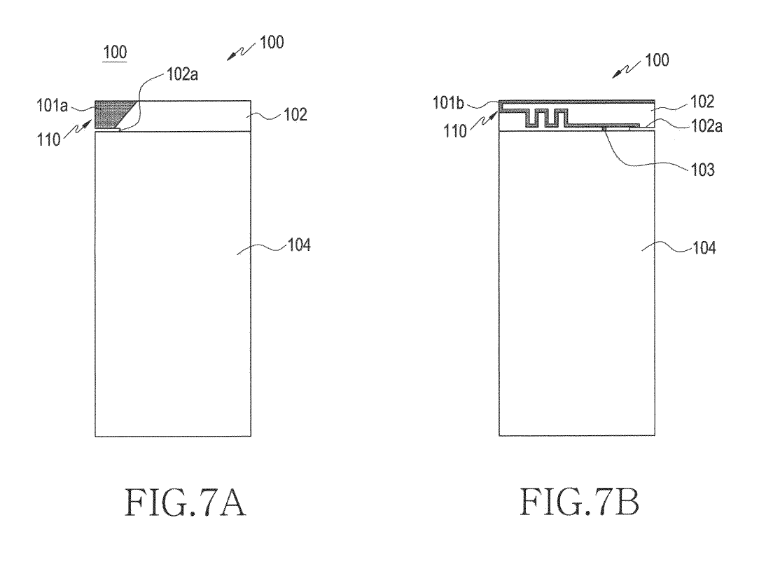

Hereinafter, an antenna device according to the first embodiment of the present invention will be described with reference to FIGS. 7 to 10.

FIGS. 7A and 7B are schematic views illustrating an antenna device according to the first embodiment of the present invention, wherein FIG. 7A illustrates a surface of the antenna device and FIG. 7B illustrates a rear surface of the antenna device.

Referring to FIGS. 7A and 7B, the antenna device 100 includes an antenna element 101, a dielectric body 102, a power supply 103, and a ground plate 104. The antenna element 101 includes a wide-band monopole antenna 101a having a tapered shape of FIG. 7A and an L-shaped foldable antenna 101b having a serpentine shape of FIG. 7B. The antenna element 101 has an electromagnetic field of ¼λ. The power supply 103 is disposed between the wide-band monopole antenna 101a and the L-shaped foldable antenna 101b and is disposed around an intermediate portion of the upper edge of the ground plate 104. An antenna unit 110 including the antenna element 101, the dielectric body 102, and the power supply 103 is disposed at a lengthwise end of the ground plate 104.

The antenna element 101 may be formed by a Molded Interconnect Device (MID) technology or be formed on a surface of the dielectric body 102 by integrally forming a metal sheet. For example, the width of a conductor of the L-shaped foldable antenna 101b may be 1 mm. The dielectric body 102 may be made of an ABS (acrylonitrile, butadiene, and styrene) resin. The antenna unit 110 has the shape of a thin film having a length L of 50 mm, a width W of 10 mm, and a height H of 5 mm and a volume of 2.5 cc. The ground plate 104 has the shape of a thin film of 100 mm×50 mm.

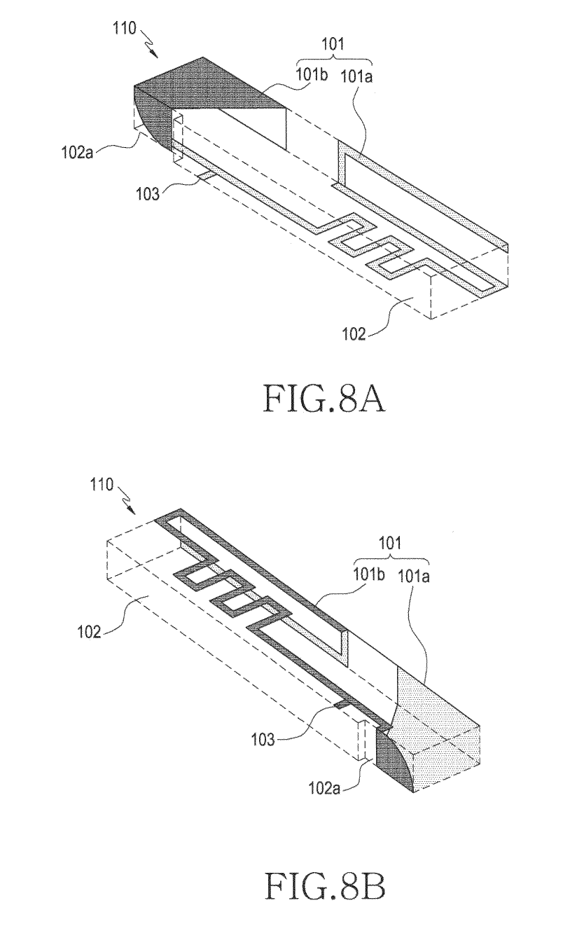

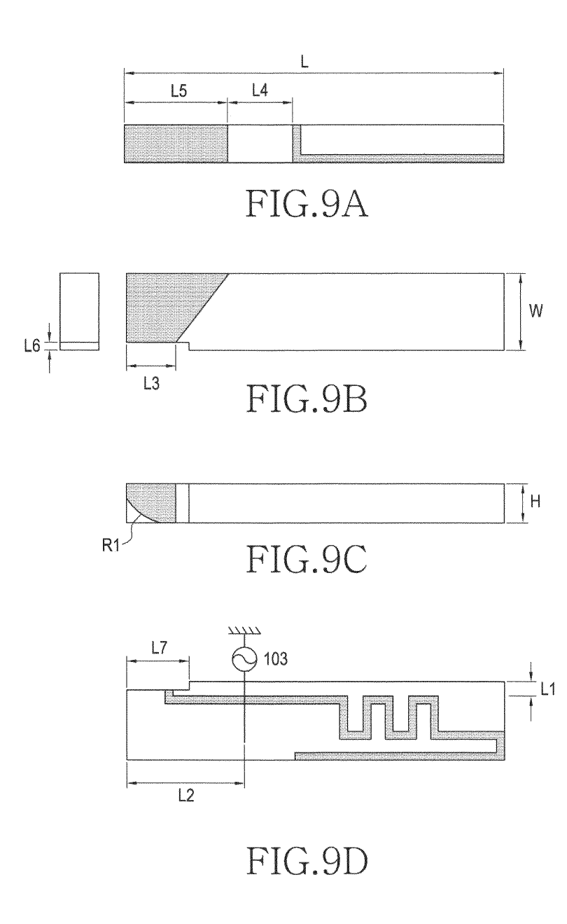

FIGS. 8A and 8B illustrate perspective views of an antenna unit of the antenna device of FIG. 7, wherein FIG. 8A illustrates a state in which a wide-band monopole antenna is disposed on one surface along the lengthwise direction of the dielectric body and FIG. 8B illustrates a state in which an L-shaped foldable antenna is disposed on one surface along the lengthwise direction of the dielectric body. The arrangement of the wide-band monopole antenna 110a and the L-shaped foldable antenna 101b in the antenna unit 110b will be described below with reference to FIG. 9.

FIGS. 9A through 9D illustrate four surfaces of the antenna unit of the antenna device of FIG. 7, wherein FIG. 9A illustrates a top surface of the antenna unit shown in FIG. 7, FIG. 9B illustrates a surface of the antenna unit shown in FIG. 7A, FIG. 9C illustrates a bottom surface of the antenna unit shown in FIG. 7, and FIG. 9D illustrates a surface of the antenna unit shown in FIG. 7B.

Referring to FIGS. 8A-8B and 9A-9D, the wide-band monopole antenna 101a is formed along the three surfaces of FIGS. 9A to 9C among the side surfaces of the dielectric body 102 having a substantially rectangular parallelepiped thin film shape. The L-shaped foldable antenna 101b is formed along the two surfaces of FIGS. 9A and 9D among the side surfaces of the dielectric body 102.

The arrangement positions of the wide-band monopole antenna 101a and the L-shaped foldable antenna 101b are not limited to ends of the dielectric body 102 illustrated in the drawings but may also be disposed on two opposite sides of the dielectric body 102.

As illustrated in FIGS. 7A to 9D, the dielectric body 102 may have a rectangular parallelepiped shape having a cutaway end portion 102a. As illustrated in FIGS. 9B and 9D, the size of the cutaway portion 102a of the dielectric body 102 may have L7 of 10 mm and L6 of 1 mm, and its height may be the same as that H of the dielectric body 102 of FIG. 9C, i.e. 5 mm. The cutaway portion 102a of the dielectric body 102 is formed such that the wide-band monopole antenna 101a does not contact with the ground plate 104.

The sizes of the respective portions of the antenna element 101 illustrated as L1 to L5 in FIGS. 9A-9D may be suitably adjusted according to the corresponding frequency bands and impedance matching. Since the antenna device 60 of FIG. 5B can have the high band resonance characteristics by adding the element portion 61a to the serpentine antenna element 41 of the antenna device 40 of FIG. 3B, it can be expected that the size of the L-shaped foldable antenna 101b of the antenna device 100 having a serpentine shape influences its performance at a low band frequency and the size of the wide-band monopole antenna 101a influences its performance at a high band frequency. Thus, the lengths L1 and L2 related to the design of the L-shaped foldable antenna 101b are adjusted according to the impedance matching at a low band frequency based on the assumption and the lengths L3, L4, and L5 related to the design of the wide-band monopole antenna 101a are adjusted according to the impedance matching at a high band frequency to perform an optimum design corresponding to a desired frequency. Here, the portions of the antenna element 110 may have L1 of 1 to 2 mm, L2 of 12 to 20 mm, L3 of 5 to 10 mm, L4 of 10 mm, and L5 of 10 to 20 mm. The size of the tapered shape of the wide-band monopole antenna 101a indicated by R1 in FIG. 9C may also be suitably adjusted according to the wide band and impedance matching of a high band frequency.

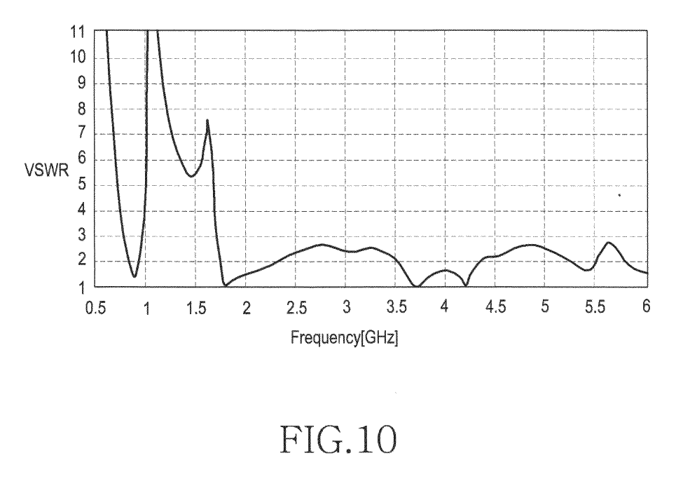

Next, the VSWR characteristics of the antenna device 100 having the antenna portion 110 of FIGS. 7 and 9 will be described with reference to FIG. 10.

FIG. 10 is a graph illustrating the VSWR characteristics of the antenna device 100 according to the first embodiment of the present invention.

Referring to FIG. 10, it can be seen that since the antenna device 100 covers GSM850, GSM900, DCS (1.71 to 1.88 GHz), PCS (1.85 to 1.99 GHz), UMTS, mWimax, and UWB Low-Band (3.4 to 4.8 GHz) as frequency bands and covers VSWR<3 at the frequency band of 1.71 to 4.8 GHz, it has excellent electrical characteristics.

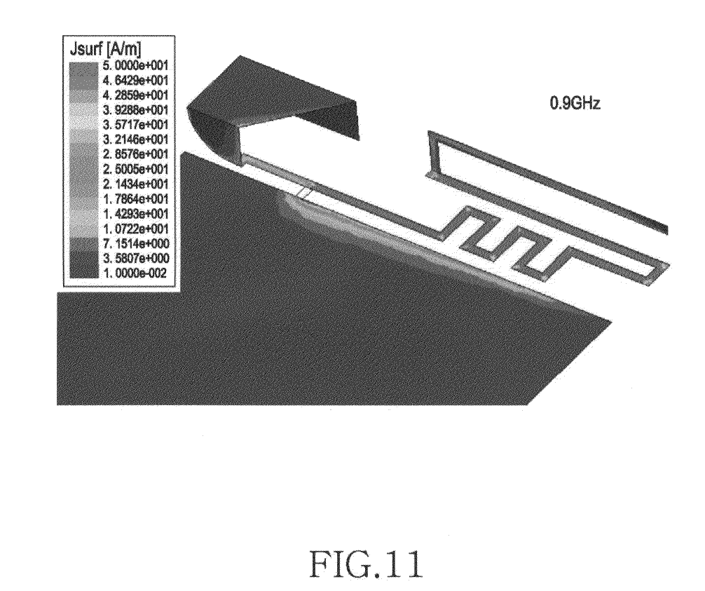

Hereinafter, the operation principle of the antenna device 100 according to the first embodiment of the present invention will be described with reference to FIGS. 11 to 18.

FIGS. 11 to 17 illustrate results obtained by analyzing the current distribution of the antenna element 101 of the antenna device 100 at respective frequencies using simulations.

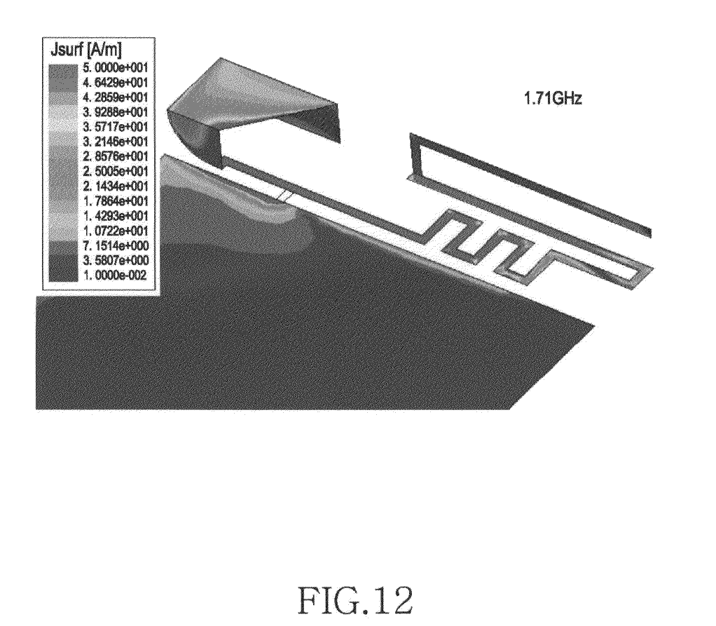

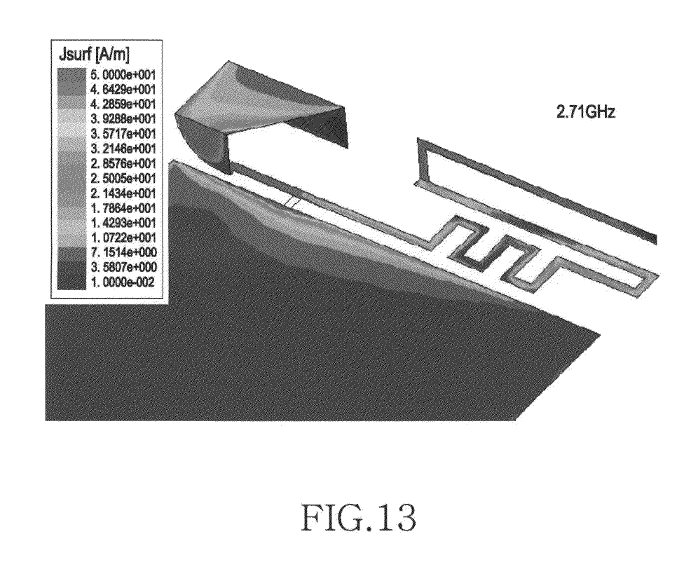

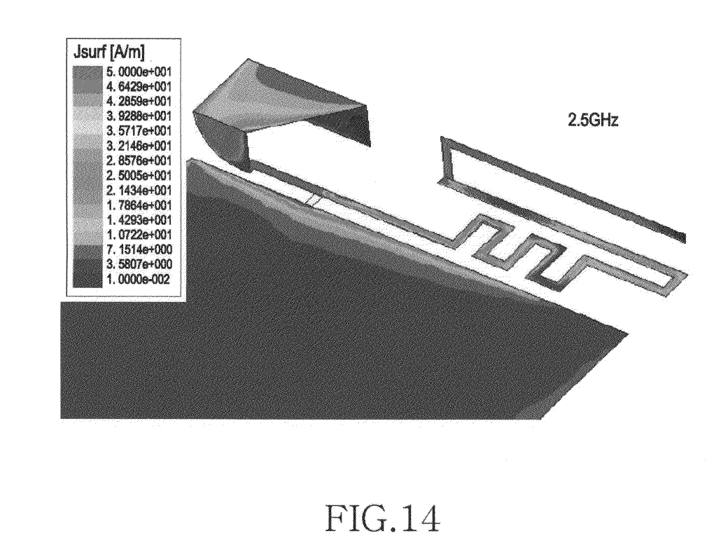

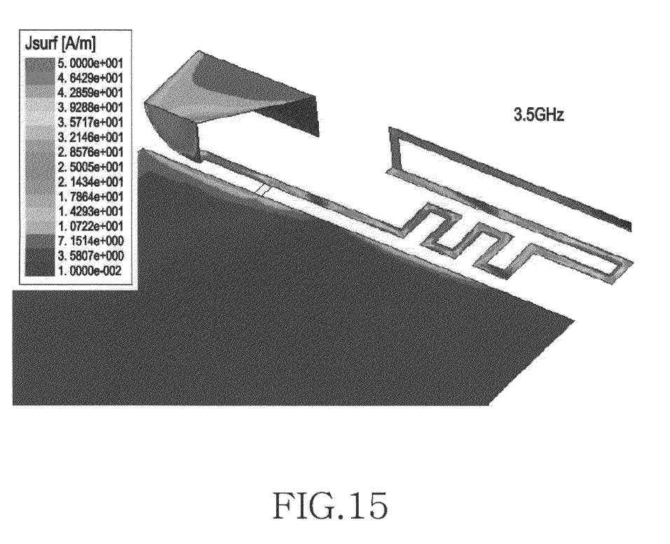

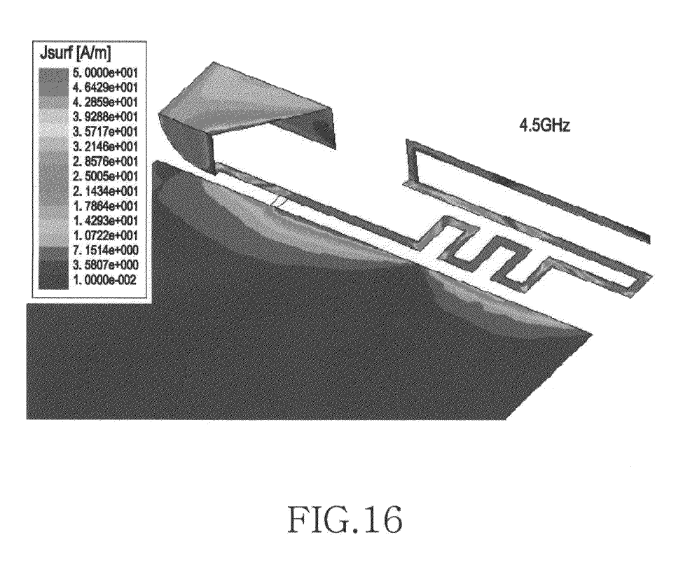

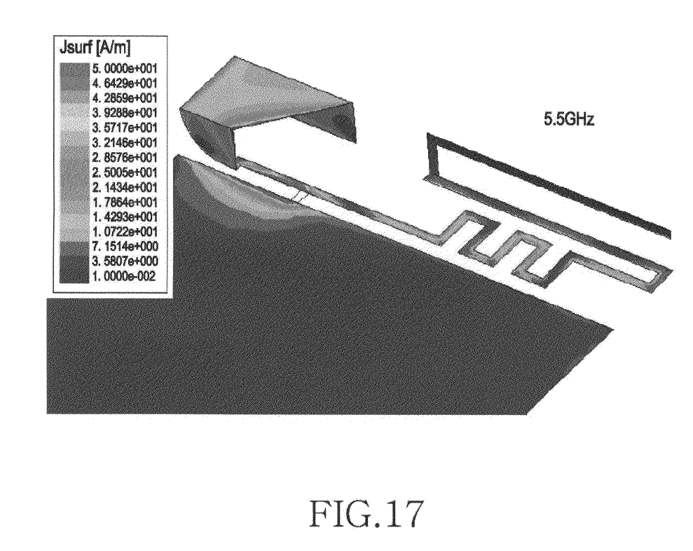

FIG. 11 is a view illustrating distribution of currents at the frequency of 0.9 GHz in the antenna device according to the first embodiment of the present invention, FIG. 12 is a view illustrating distribution of currents at the frequency of 1.71 GHz in the antenna device according to the first embodiment of the present invention, FIG. 13 is a view illustrating distribution of currents at the frequency of 2.17 GHz in the antenna device according to the first embodiment of the present invention, FIG. 14 is a view illustrating distribution of currents at the frequency of 2.5 GHz in the antenna device according to the first embodiment of the present invention, FIG. 15 is a view illustrating distribution of currents at the frequency of 3.5 GHz in the antenna device according to the first embodiment of the present invention, FIG. 16 is a view illustrating distribution of currents at the frequency of 4.5 GHz in the antenna device according to the first embodiment of the present invention, and FIG. 17 is a view illustrating distribution of currents at the frequency of 5.5 GHz in the antenna device according to the first embodiment of the present invention.

Referring to FIG. 11, the current distribution at the serpentine shape of the L-shaped foldable antenna 101b at the frequency of 0.9 GHz is very strong and the current distribution at the wide-band monopole antenna 101a is nearly zero.

Referring to FIGS. 12 to 17, the current distribution at the serpentine shape of the L-shaped foldable antenna 101b at the frequency of more than 1.71 GHz is weak and the current distribution at the wide-band monopole antenna 101a is strong.

Due to the current distributions illustrated in FIGS. 11 to 17, in the antenna device 100 according to the first embodiment of the present invention, since an optimizing design is performed to the L-shaped foldable antenna 101b for the low frequency band (GSM850/900) and an optimizing design is performed to the wide-band monopole antenna 101a for the high frequency band (DCS/PCS+UMTS+mWimax+UWB Low), it is considered that the L-shaped foldable antenna 101b is operated in response to a desired low band frequency and the wide-band monopole antenna 101a is operated in response to a desired high band frequency.

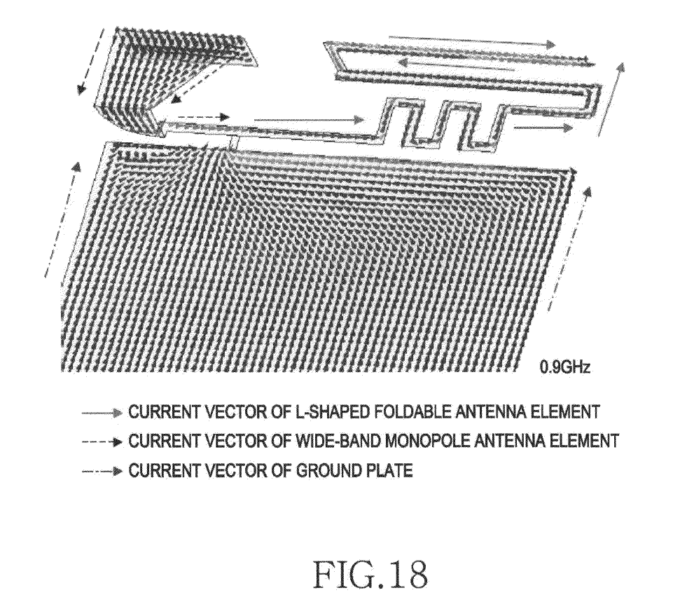

A vector analysis on current amplitude was performed using an electromagnetic simulation to verify a phenomenon in which almost no current flows through the wide-band monopole antenna 101a of FIG. 11 at the frequency of 0.9 GHz. The result is shown in FIG. 18.

FIG. 18 is a view illustrating current vectors generated when a current flows for a predetermined period of time at the frequency of 0.9 GHz in the antenna element 101 according to the first embodiment of the present invention

In order to efficiently irradiate electric waves in a grounded antenna device, it is generally necessary to allow a balanced current to flow with the direction of the current being adjusted by an element and a ground plate. Referring to FIG. 18, it can be seen that the L-shaped foldable antenna 101b according to another embodiment of the present invention is ideally operated as an antenna and the direction of the current is matched to the ground plate 104.

It can be considered that since a current reverse to the current of the ground plate 104 is generated in the wide-band monopole antenna 101a, unbalanced currents are generated in the wide-band monopole antenna 101a and the ground plate 104, making it difficult to irradiate electric waves. Thus, it can be considered that the wide-band monopole antenna 101a designed for a high frequency band is hardly interfered at all in the operation of the L-shaped foldable antenna 101b designed for a low frequency band. That is, the antenna device 100 can have excellent VSWR characteristics at a low frequency band with the L-shaped foldable antenna 101b and have excellent VSWR characteristics at a high frequency band with the wide-band monopole antenna 101a.

Generally, if an antenna device is used for multiple bands or is made small-sized, the bandwidth of the antenna device becomes narrower or the impedance of the antenna is deteriorated by increasing the Q value representing the sharpness of the resonance, lowering the impedance of the antenna, or coupling electromagnetic fields between antenna elements.

However, in the antenna device 100 according to the first embodiment of the present invention, power is supplied to the vicinity of an intermediate portion of an edge of the ground plate 104, the L-shaped foldable antenna 101b and the wide-band monopole antenna are disposed on opposite sides of the antenna unit 110, and the antenna element 101 around the power supply 103 is disposed in the vicinity of the ground plate 104, in order to perform an optimum design according to the in-use frequency band. Accordingly, according to the antenna device 100, the L-shaped foldable antenna 101b and the wide-band monopole antenna 101a of the antenna device 100 reduce the mutual interference at a low frequency band and a high frequency band, making it possible to have the wide band VSWR characteristics without the structure of the antenna device and support multiple bands without being made small-sized.

The recent wireless communication apparatus tends to be multi-functioned by providing various wireless systems in addition to the cellular system, but an increase in the number of mounted antennas due to increase in the number of systems is difficult due to installation space of the frame body or cost issues.

Therefore, according to the antenna device 100 according to the first embodiment of the present invention, it is possible to cover the frequency band of a wireless system in use for a wireless communication apparatus at a frequency of below 60 GHz and it is also possible to save the costs by reducing the number of mounted antennas.

Hereinafter, an antenna device according to another embodiment of the present invention which is manufactured by the design method of the antenna device 100 according to the first embodiment of the present invention will be described.

Recently, due to emphases on the design quality of a smart phone or demands on the small size of the terminal itself, it is preferable to reduce the size of the antenna unit 110 to be less than 2.5 cc.

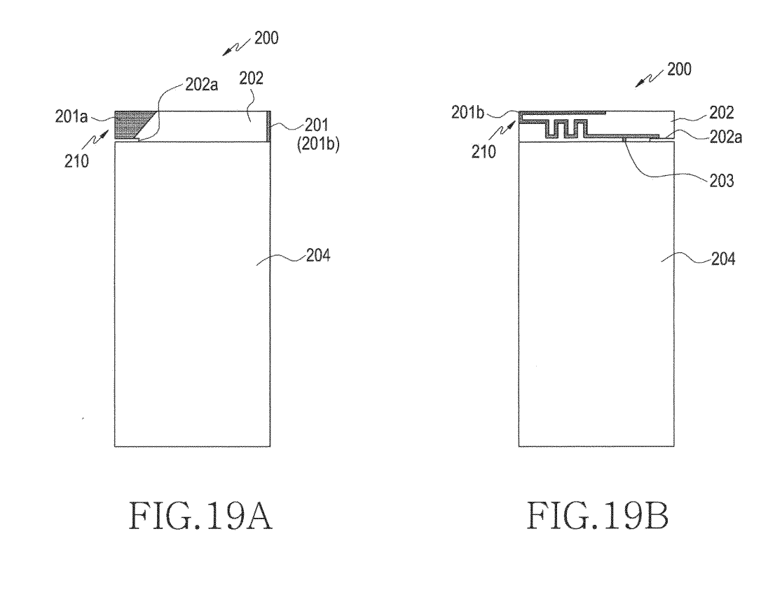

Thus, an antenna device according to a second embodiment of the present invention whose antenna unit has a thickness of 2 mm and a volume of 1 cc will be described with reference to FIGS. 19 to 21.

### Second Embodiment

FIGS. 19A and 19B are schematic views illustrating an antenna device according to a second embodiment of the present invention, wherein FIG. 19A illustrates a surface of the antenna device and FIG. 19B illustrates a rear surface of the antenna device.

Referring to FIGS. 19A and 19B, the antenna device 200 includes an antenna element 201, a dielectric body 202, a power supply 203, and a ground plate 204. The antenna element 201 includes a wide-band monopole antenna 201a having a tapered shape of FIG. 19A and an L-shaped foldable antenna 201b having a serpentine shape of FIG. 19B. The power supply 203 is disposed between the wide-band monopole antenna 201a and the L-shaped foldable antenna 201b and is disposed around an intermediate portion of the upper edge of the ground plate 204. An antenna unit 210 including the antenna element 201, the dielectric body 202, and the power supply 203 is disposed at a lengthwise end of the ground plate 204.

The antenna unit 210 has the shape of a thin film having a length L of 50 mm, a width W of 10 mm, and a height H of 2 mm and a volume of 1 cc. The ground plate 204 has the shape of a thin film of 100 mm×50 mm.

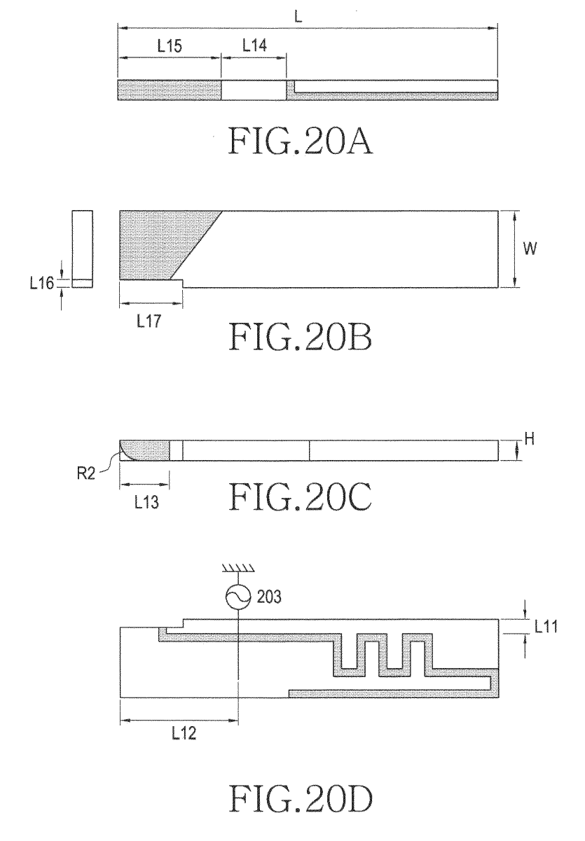

FIGS. 20A through 20D illustrate four surfaces of the antenna unit of the antenna device of FIG. 19, wherein FIG. 20A illustrates a top surface of the antenna unit 210 shown in FIG. 19, FIG. 20B illustrates a surface of the antenna unit 210 shown in FIG. 19A, FIG. 20C illustrates a bottom surface of the antenna unit shown in FIGS. 19A and 19B, and FIG. 20D illustrates a surface of the antenna unit shown in FIG. 19B.

Referring to FIGS. 19A-19B and 20A-20D, the wide-band monopole antenna 201a is formed along three surfaces of the dielectric body 202 shown in FIGS. 19A to 19C. The L-shaped foldable antenna 201b is formed along three surfaces shown in FIGS. 19A, 19B, and 19C. The dielectric body 202 has a cutaway portion 202a. The cutaway portion 202a of the dielectric body 202 is formed such that the wide-band monopole antenna 201a does not contact with the ground plate 204. As illustrated in FIG. 20B, the size of the cutaway portion 202a of the dielectric body 202 may have L17 of 10 mm and L16 of 1 mm, and its height may be the same as that H of the dielectric body 202, i.e. 5 mm.

An impedance can be adjusted by suitably adjusting the sizes L11 to L15 of the element 201 shown in FIG. 20 as in the first embodiment of the present invention. For example, the portions of the antenna element 210 may have L11 of 1 to 2 mm, L12 of 12 to 20 mm, L13 of 7 mm, L4 of 5 mm, and L5 of 10 to 20 mm. The size of the tapered shape of the wide-band monopole antenna 201a indicated by R2 may also be suitably adjusted according to the wide band and impedance matching of a frequency as described in the first embodiment of the present invention.

The antenna device 200 has the same configuration as the antenna device 100 except for the configuration of the antenna element 201 and the size of the antenna unit 210.

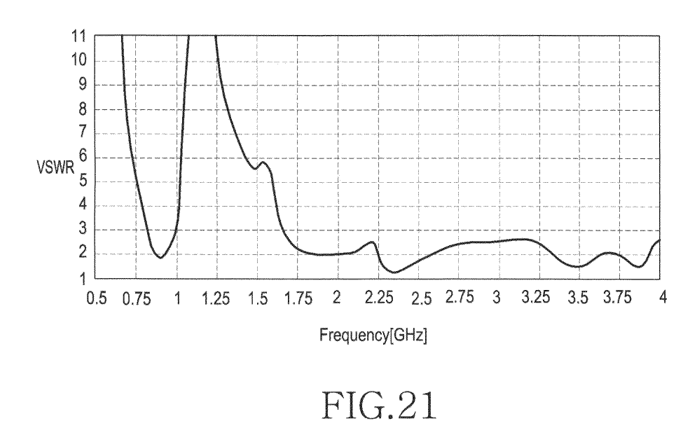

The VSWR characteristics of the antenna device 200 including the antenna unit 210 shown in FIGS. 19 and 20 will be described with reference to FIG. 21.

FIG. 21 is a graph illustrating the VSWR characteristics of the antenna device 200 shown in FIG. 19.

Referring to FIG. 21, it can be seen that even when the antenna unit 210 is made small-sized so as to have a length of 50 mm, a width of 10 mm, and a height of 2 mm and a volume of approximately 1 cc, a small-sized wide multi-band antenna covering the characteristics of VSWR<3.0 at a frequency of 0.824 to 0.96 GHz and 1.71 to 4 GHz, which is a frequency band in use for a current cellular phone, can be realized.

Further, although the performance of a cellular built-in multi-band antenna is generally seriously deteriorated at a low band frequency (GSM850/900) if the antenna becomes smaller, an antenna whose deterioration is restrained due to its small size can be realized as the L-shaped foldable antenna 201b is operated with the interference of a wide-band monopole antenna 201a in use for a high band frequency being extremely restrained at a low band frequency according to the antenna unit 200.

### Third Embodiment

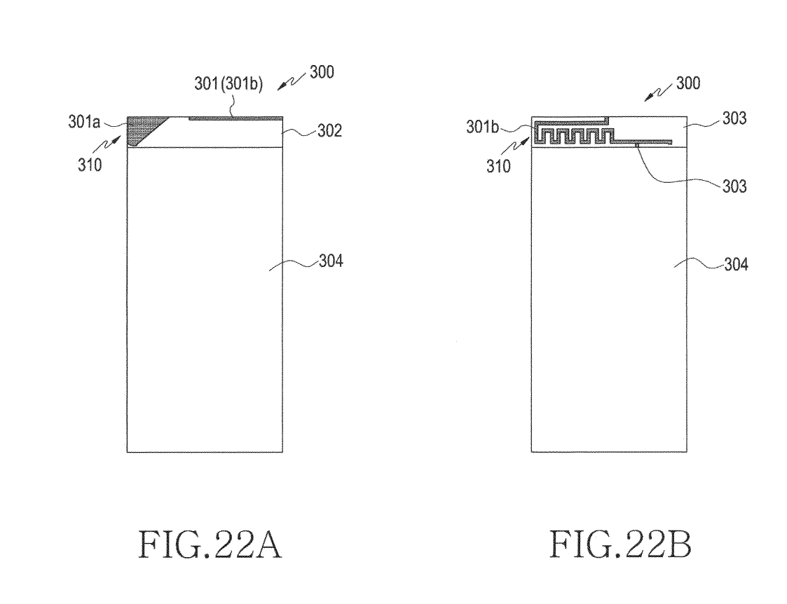

Next, an antenna device according to a third embodiment of the present invention, where the size of the antenna unit is as small as 0.5 cc, will be described with reference to FIGS. 22 to 24.

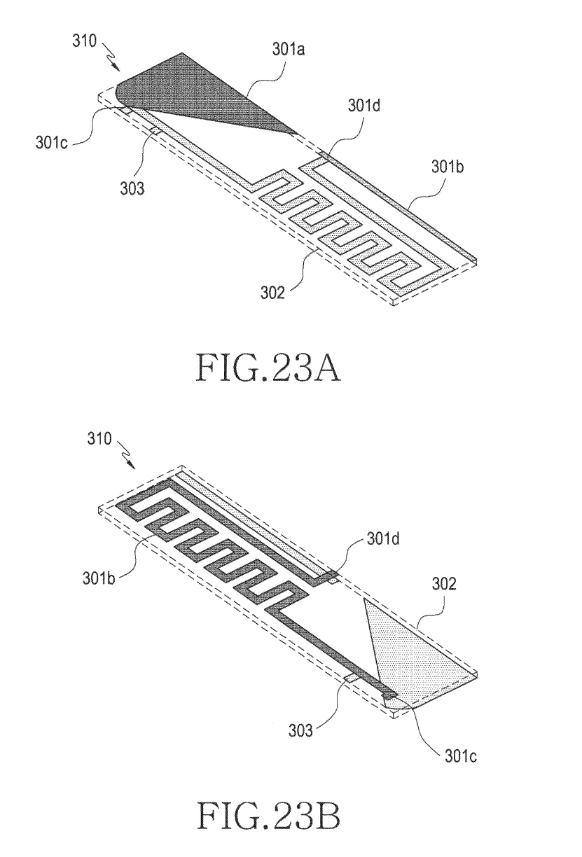

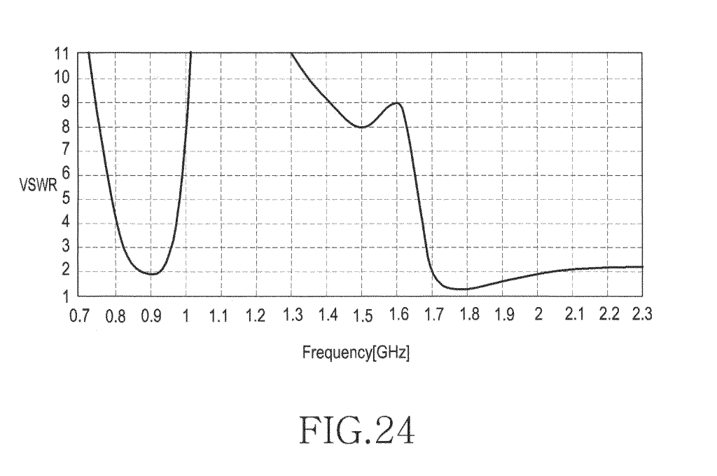

FIGS. 22A and 22B are schematic views illustrating an antenna device according to a third embodiment of the present invention, wherein FIG. 22A illustrates a surface of the antenna device and FIG. 22B illustrates a rear surface of the antenna device. FIGS. 23A and 23B illustrates a perspective view of an antenna unit of the antenna device of FIGS. 22A and 22B, wherein FIG. 23A illustrates a state in which a wide-band monopole antenna is disposed on one surface along the lengthwise direction of the dielectric body and FIG. 23B illustrates a state in which an L-shaped foldable antenna is disposed on one surface along the lengthwise direction of the dielectric body. FIG. 24 is a graph illustrating the VSWR characteristics of the antenna devices of FIG. 22.

Referring to FIGS. 22A, 22B, 23A, and 23B, the antenna device 300 includes an antenna element 301, a dielectric body 302, a power supply 303, and a ground plate 304. The antenna element 301 includes a wide-band monopole antenna 301a having a tapered shape, and an L-shaped foldable antenna 301b having a serpentine shape. As illustrated in FIGS. 23A and 23B, the wide-band monopole antenna 301a and the L-shaped foldable antenna 301b are formed on two opposite surfaces of the dielectric body 302, and two through-holes 301c and 301d are formed in the interior of the dielectric body 302. The wide-band monopole antenna 301a and the L-shaped foldable antenna 301b are electrically connected to each other with the through-hole 301c being a through-electrode. A portion of the L-shaped foldable antenna 301b formed on the same surface as the wide-band monopole antenna 301a is electrically connected to the L-shaped foldable antenna 301b with the through-hole 301d being a through-electrode. The power supply 303 is disposed not at a corner of the ground plate 304 but around an intermediate portion of the upper edge of the ground plate 304, and the antenna unit 310 including the antenna element 301, the dielectric body 302, and the power supply 303 is disposed at a lengthwise end of the ground plate 304.

The antenna unit 310 is a thin film having a length of 50 mm, a width of 12.5 mm, and a height of 0.8 mm and a volume of 0.5 cc. Unlike the antenna units 110 and 210, the dielectric body 302 of the antenna unit 310 has a parallelepiped shape, a portion of which is not void. The dielectric body 302 does not need a cutaway portion since the wide-band monopole antenna 301a of the antenna element 301 does not contact with the ground plate 304. The ground plate 304 is a thin film of 100 mm×50 mm.

When the antenna unit 310 is formed, FR-4 may be used as a substrate material. In this situation, manufacturing costs can be reduced by using the printed board as it is.

The antenna device 300 has the same configuration as the antenna device 100 except for the configuration of the antenna element 301 and the size and shape of the antenna unit 310.

Referring to FIG. 24, it can be seen that even when the antenna unit 310 is made small-sized so as to have a length of 50 mm, a width of 12.5 mm, and a height of 0.8 mm and a volume of approximately 0.5 cc, a small-sized wide multi-band antenna covering the characteristics of VSWR<3.0 at a frequency of 0.824 to 0.96 GHz and 1.71 to 4 GHz, which is a frequency band in use for a current cellular phone, can be realized. Furthermore, since the height of the antenna device 300 is 0.8 mm, which is lower than in the first and second embodiments of the present invention, the capacity for mounting it to a portable terminal can be reduced.

### Fourth Embodiment

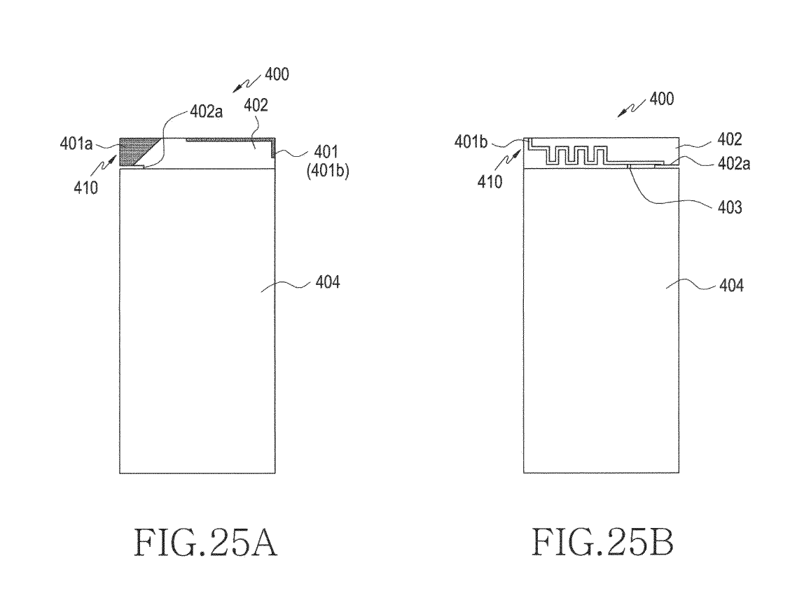

An antenna device according to a fourth embodiment of the present invention, where the size of an antenna unit is made small sized to 1.5 cc, will be described with reference to FIGS. 25 to 27.

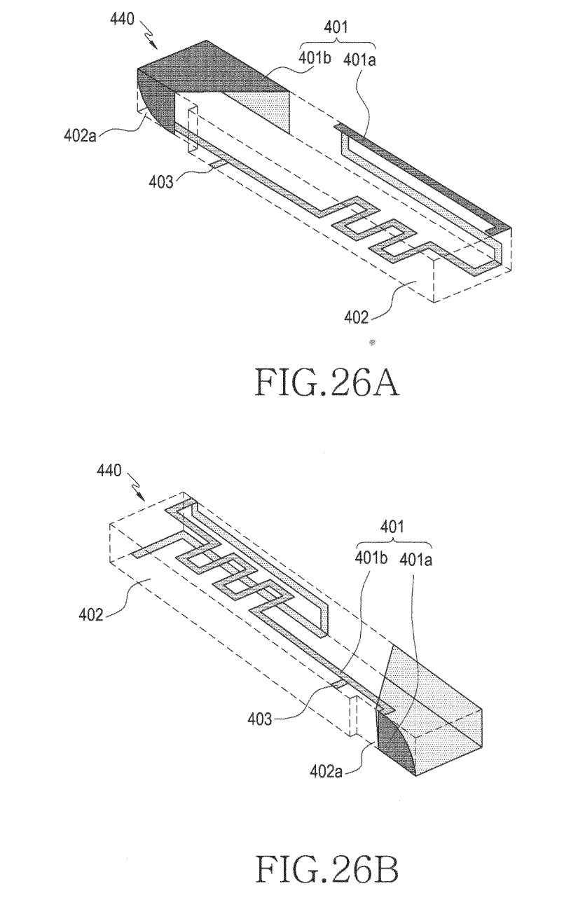

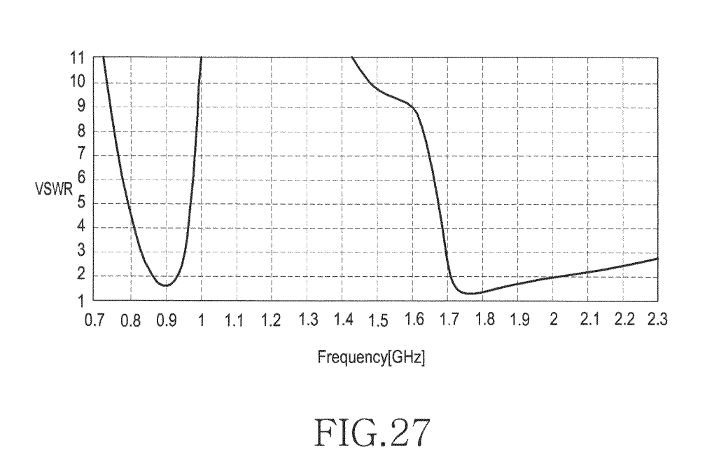

FIGS. 25A and 25B are schematic views illustrating an antenna device according to a fourth embodiment of the present invention, wherein FIG. 25A illustrates a surface of the antenna device 400 and FIG. 25B illustrates a rear surface of the antenna device 400. FIGS. 26A and 26B illustrate a perspective view of an antenna unit 410 of the antenna device 400 of FIGS. 25A and 25B, wherein FIG. 26A illustrates a state in which a wide-band monopole antenna 401a is disposed on one surface along the lengthwise direction of the dielectric body 402 and FIG. 26B illustrates a state in which an L-shaped foldable antenna 401b is disposed on one surface along the lengthwise direction of the dielectric body 402. FIG. 27 is a graph illustrating the VSWR characteristics of the antenna device 400 of FIG. 25.

Referring to FIGS. 25 and 26, the antenna device 400 includes an antenna element 401, a dielectric body 402, a power supply 403, and a ground plate 404. The antenna element 401 includes a wide-band monopole antenna 401a having a tapered shape, and an L-shaped antenna 401b having a serpentine shape. As illustrated in FIG. 26, the wide-band monopole antenna 401a is formed along three surfaces of the dielectric body 402. The L-shaped foldable antenna 401b is also formed along three surfaces of the dielectric body 402. The power supply 403 is formed around an intermediate portion of the upper edge of the ground plate 404, and an antenna unit 410 including the antenna element 401, the dielectric body 402, and the power supply 403, is disposed at a lengthwise end of the ground plate 404.

The antenna unit 410 is a thin film having a length of 50 mm, a width of 7 mm, and a height of 5 mm and has a volume of 1.75 cc. The ground plate 404 is a thin film having a size of 100 mm×50 mm

The antenna device 400 has the same configuration as the antenna device 100 except for the configuration of the antenna element 401 and the size of the antenna unit 410.

Referring to FIG. 27, even when the antenna unit 410 is made small-sized so as to have a length of 50 mm, a width of 7 mm, and a height of 5 mm and a volume of approximately 1.75 cc, a low posture antenna covering the characteristics of VSWR<3.0 at frequency of 0.824 to 0.96 GHz and 1.71 to 4 GHz, which is a frequency band in use for a current cellular phone, can be realized, satisfying the low posture tendency of the current portable terminals.

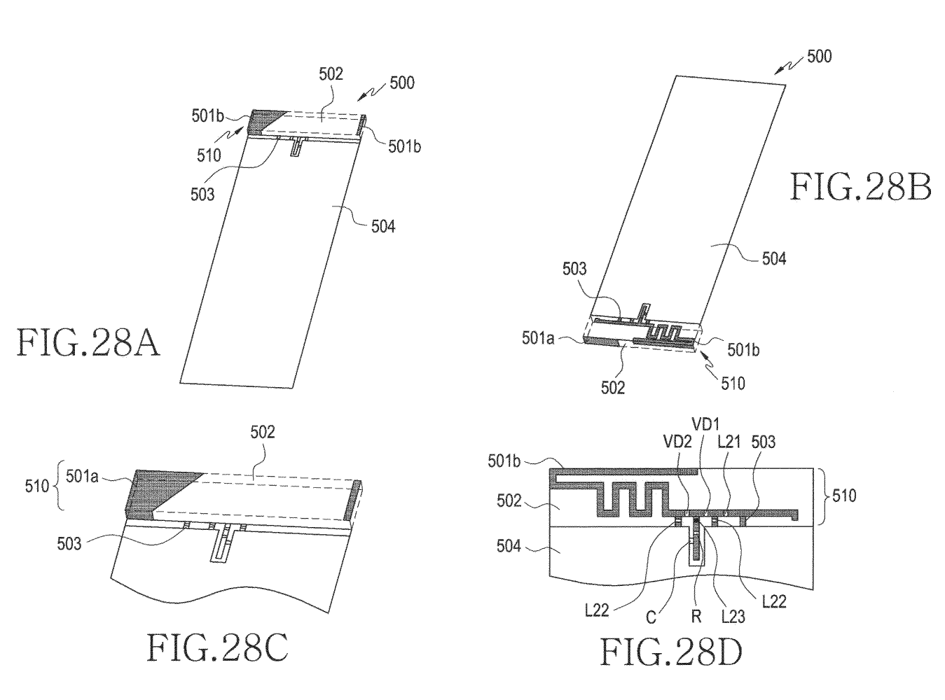

The specification of LTE (Long Term Evolution) has been determined as a standard for a cellular phone and LTE700/LTE2600 (0.698 to 0.806 GHz, 2.5 to 2.69 GHz) may be used in North America. Thus, an antenna device according to a fifth embodiment of the present invention, which can be tunable so as to correspond to a plurality of frequencies such as LTE700 or LTE2600, will be described with reference to FIGS. 28 to 30.

### Fifth Embodiment

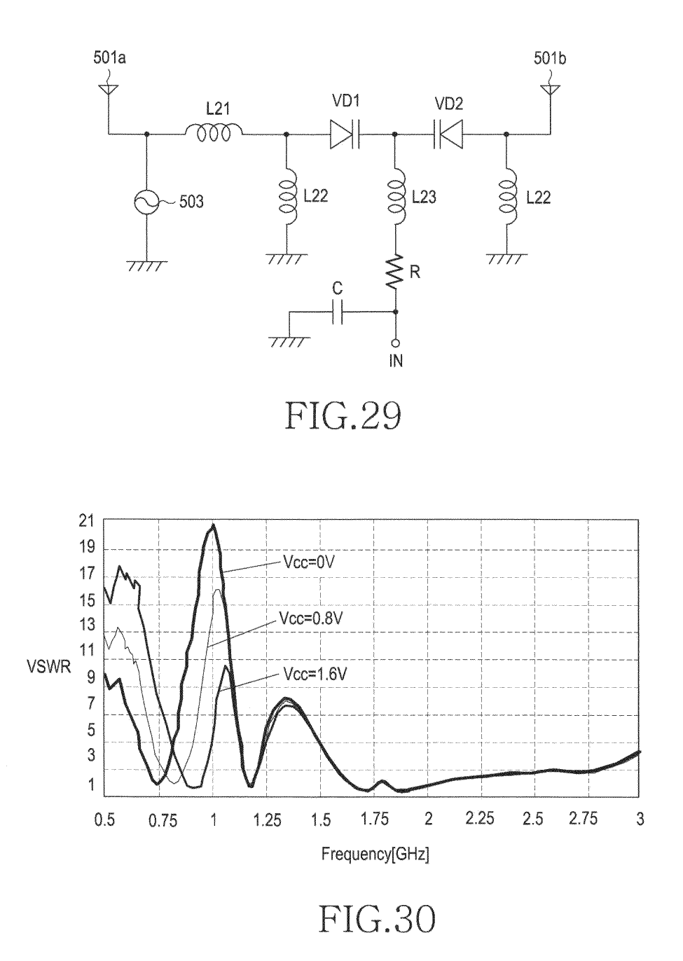

FIGS. 28A through 28B illustrate an antenna device 500 according to a fifth embodiment of the present invention, wherein FIG. 28A is a perspective view of the antenna device 500 seen from the top, FIG. 28B is a perspective view of the antenna device 500 seen from the bottom, FIG. 28C is an enlarged perspective view of the antenna unit 510 shown in FIG. 28C, and FIG. 28D is an enlarged top view of the antenna unit 510 shown in FIG. 28B. FIG. 29 is an equivalent circuit diagram illustrating a tunable circuit formed in the antenna unit 510 shown in FIG. 28. FIG. 30 is a graph illustrating the VSWR characteristics shown when a voltage is varied in the antenna device 500 of FIG. 28.

Referring to FIGS. 28A-28D, the antenna device 500 includes an antenna element 501, a dielectric body 502, a power supply 503, and a ground plate 504. The antenna element 501 includes a wide-band monopole antenna 501a having a tapered shape and an L-shaped foldable antenna 501b having a serpentine shape. The power supply 503 is disposed around an intermediate portion of the upper edge of the ground plate 504, and the antenna unit 510, including the antenna element 501, the dielectric body 502, and the power supply 503, is disposed at a lengthwise end of the ground plate 504.

FIG. 28D is a top view illustrating a portion of the tunable circuit of the antenna unit 510. A capacitor C, a resistor R, coils L21 to L23, and variable capacity diodes VD1 and VD2 are disposed at each position indicated in the figure on an element constituting the L-shaped foldable antenna 501b of FIG. 28D. The equivalent circuit to the tunable circuit constituted by the electrical parts is illustrated in FIG. 29, and the circuit configuration will be additionally described.

A bias voltage Vcc is input from an external power source (not shown) to an input terminal IN of FIG. 29. An end of the capacitor C and an end of the resistor R are connected in parallel around the input terminal IN. The opposite end of the capacitor C is grounded. That is, the opposite end of the capacitor C of FIG. 28D is electrically connected to the ground plate 504. An end of the coil L23 is connected in series to the opposite end of the resistor R, and cathode terminals of the variable capacity diodes VD1 and VD2 are connected in parallel to the opposite end of the coil L23. Ends of the coils L21 and L22 are connected in parallel to the anode terminal of the variable capacity diode VD1. The opposite end of the coil L22 is grounded. Ends of the power supply 5603 and the wide-band monopole antenna 501a are connected in parallel to the opposite end of the coil L21. Ends of the coil L22 and the L-shaped foldable antenna 501b are connected in parallel to the anode terminal of the variable capacity diode VD2. The opposite end of the coil L22 is grounded.

In the equivalent circuit of FIG. 29, the circuit devices are designed to be varied such that the coil L21 is 22 nH, the coil L2 is 220 nH, the coil L3 is 180 nH, the resistance R is 1 kΩ, the capacitance is 180 pF, and the bias voltage Vcc is 0.1 to 1.6 V.

The antenna unit 510 may be a thin film having a length of 50 mm, a width of 10 mm, and a height of 3 mm and a volume of 1.5 cc. When the dielectric body 502 is formed of an ABS resin, the antenna unit 510 may have a length of 50 mm, a width of 10 mm, and a height of 2.2 mm. When the dielectric body 502 is formed of FR-4, the antenna unit 510 may have a length of 50 mm, a width of 10 mm, and a height of 0.8 mm. The ground plate 504 is a thin film having a size of 110 mm×50 mm.

Referring to FIG. 30, a resonance frequency can be varied at a low band frequency of LTE700 to GSM850/900 by mounting a tuning circuit and varying a bias voltage VCC applied to the input terminal IN to vary the capacities of the variable capacity diodes VD1 and VD2 and a high band frequency including DCS/PCS/UMTS and LTE2600 can be covered, making it possible to realize a tunable antenna corresponding to the existing cellular band and the LTE band.

Referring to FIG. 30 again, when the bias voltage is varied to 0 V, 0.8 V, and 1.6 V, a frequency is merely changed at a high band and can be varied at a low frequency band. As described above, the interference between the L-shaped foldable antenna 501b and the wide-band monopole antenna 501a are extremely restrained at a low band frequency and a high band frequency and a tuning circuit is designed on the element of the L-shaped foldable antenna 501b, merely influencing the operation at a high band frequency and realizing the desired resonance characteristics at a low band frequency.

An antenna device according to the present invention can cover a wide frequency band of a wireless system in use for a wireless communication device without increasing the number of mounted antennas. Furthermore, an antenna device according to the present invention can provide a small-sized antenna device and a wireless communication apparatus including the same.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An antenna device comprising:
a ground plate;
a dielectric body disposed at an end of the ground plate;
an L-shaped foldable antenna disposed at one side of the dielectric body;
a wide-band monopole antenna disposed at an opposite side of the dielectric body; and
a power supply disposed between the L-shaped foldable antenna and the wide-band monopole antenna.

2. The antenna device of claim 1, wherein a portion of the L-shaped foldable antenna is serpentine and a portion of the wide-band dipole antenna is tapered.

3. The antenna device of claim 1, wherein the power supply is disposed adjacent to an intermediate portion of the end of the ground plate.

4. The antenna device of claim 1, wherein portions of the L-shaped foldable antenna and the wide-band monopole antenna are disposed in the vicinity of the ground plate.

5. The antenna device of claim 1, wherein the L-shaped foldable antenna includes a tunable circuit comprising a plurality of variable capacitance diodes, and if a bias voltage applied from an external power source is varied, a capacitance of at least one of the variable capacitances diode is varied such that the tunable circuit adjusts a resonance frequency of the L-shaped foldable antenna.

6. The antenna device of claim 1, wherein the dielectric body is a thin film, the L-shaped foldable antenna is disposed on one surface of the dielectric body, and the wide-band monopole antenna is disposed at one end of an opposite surface of the dielectric body.

7. The antenna device of claim 1, wherein the dielectric body is formed with a print board.

8. A wireless communication apparatus comprising:
an antenna device, the antenna device comprising:
a ground plate;
a dielectric body disposed at an end of the ground plate;
an L-shaped foldable antenna disposed at one side of the dielectric body;
a wide-band monopole antenna disposed at an opposite side of the dielectric body; and
a power supply disposed between the L-shaped foldable antenna and the wide-band monopole antenna.

9. The wireless communication apparatus of claim 8, wherein a portion of the L-shaped foldable antenna is serpentine and a portion of the wide-band dipole antenna is tapered.

10. The wireless communication apparatus of claim 8, wherein the power supply is disposed adjacent to an intermediate portion of the end of the ground plate.

11. The wireless communication apparatus of claim 8, wherein portions of the L-shaped foldable antenna and the wide-band monopole antenna are disposed in the vicinity of the ground plate.

12. The wireless communication apparatus of claim 8, wherein the L-shaped foldable antenna includes a tunable circuit comprising a plurality of variable capacitance diodes, and if a bias voltage applied from an external power source is varied, a capacitance of at least one of the variable capacitances diode is varied such that the tunable circuit adjusts a resonance frequency of the L-shaped foldable antenna.

13. The wireless communication apparatus of claim 8, wherein the dielectric body is a thin film, the L-shaped foldable antenna is disposed on one surface of the dielectric body, and the wide-band monopole antenna is disposed at one end of an opposite surface of the dielectric body.

14. The wireless communication apparatus of claim 8, wherein the dielectric body is formed with a print board.

15. An antenna device comprising:
a ground plate;
a dielectric body disposed at an end of the ground plate;
an L-shaped foldable antenna disposed at one side of the dielectric body; and
a wide-band monopole antenna disposed at an opposite side of the dielectric body.

16. The antenna device of claim 15, wherein a portion of the L-shaped foldable antenna is serpentine and a portion of the wide-band dipole antenna is tapered.

17. The antenna device of claim 15, wherein portions of the L-shaped foldable antenna and the wide-band monopole antenna are disposed in the vicinity of the ground plate.

18. The antenna device of claim 15, wherein the L-shaped foldable antenna includes a tunable circuit comprising a plurality of variable capacitance diodes, and if a bias voltage applied from an external power source is varied, a capacitance of at least one of the variable capacitances diode is varied such that the tunable circuit adjusts a resonance frequency of the L-shaped foldable antenna.

19. The antenna device of claim 15, wherein the dielectric body is a thin film, the L-shaped foldable antenna is disposed on one surface of the dielectric body, and the wide-band monopole antenna is disposed at one end of an opposite surface of the dielectric body.

20. The antenna device of claim 15, wherein the dielectric body is formed with a print board.
